(19) United States
(12) Patent Application Publication
(10) Pub. No.: US 2024/0059059 A1
(43) Pub. Date: Feb. 22, 2024

(54) LIQUID EJECTING HEAD AND LIQUID EJECTING APPARATUS

(71) Applicant: Toshiba Tec Kabushiki Kaisha, Tokyo (JP)

(72) Inventor: Masashi SHIMOSATO, Mishima Shizuoka (JP)

(21) Appl. No.: 18/324,887

(22) Filed: May 26, 2023

(30) Foreign Application Priority Data
Aug. 19, 2022 (JP) 2022-131109

(51) Int. Cl. B41J 2/045

(52) U.S. Cl. CPC B41J 2/04541; B41J 2/04581

(57) ABSTRACT

According to one embodiment, a liquid ejecting head includes a piezoelectric member, electrodes, and a wiring substrate. The piezoelectric member has a plurality of piezoelectric elements formed of a piezoelectric material. The electrodes are formed on the piezoelectric member. The wiring substrate is joined to the electrodes by solder. The solder has a melting point of less than or equal to ½ of the Curie point of the piezoelectric material.

### CROSS-REFERENCE TO RELATED APPLICATION

This application is based upon and claims the benefit of priority from Japanese Patent Application No. 2022-131109, filed Aug. 19, 2022, the entire contents of which are incorporated herein by reference.

### FIELD

Embodiments described herein relate generally to a liquid ejecting head and a liquid ejecting apparatus.

### BACKGROUND

A piezoelectric actuator using a piezoelectric material such as “PZT” (lead zirconate titanate) can be used as driving source of a liquid ejecting apparatus such as an inkjet printer head. In an inkjet printer head, a configuration in which many grooves are formed at a fine pitch in a body of piezoelectric material to provide divided columnar elements to serve as nozzle actuators is known. Wirings are connected to drive such actuators. However, if the columnar elements of the piezoelectric material are thin or fragile, it can be difficult to mount such piezoelectric actuators with adhesive or the like since when pressure is applied damage may occur. Therefore, it is considered that solder might be used for the mounting. However, when the piezoelectric actuator is heated during a mounting process, the performance of the piezoelectric material may deteriorate.

### BRIEF DESCRIPTION OF THE DRAWINGS

FIG. 1 is a cross-sectional view illustrating a configuration of an inkjet head according to an embodiment.

FIG. 2 is a cross-sectional view illustrating the configuration of an inkjet head according to an embodiment.

FIG. 3 is a cross-sectional view illustrating a configuration of a part of a flexible printed circuit (FPC) of an inkjet head according to an embodiment.

FIG. 4 is a table of correspondence between solder types and melting points.

FIG. 5 is a diagram illustrating aspects of a method for manufacturing an inkjet head according to an embodiment.

FIG. 6 is a diagram illustrating a schematic configuration of an inkjet recording apparatus.

### DETAILED DESCRIPTION

In general, according to one embodiment, a liquid ejecting head includes a piezoelectric member, electrodes, and a wiring substrate. The piezoelectric member has a plurality of piezoelectric elements formed of a piezoelectric material. The electrodes are formed on the piezoelectric member. The wiring substrate is joined to the electrodes by solder. The solder has a melting point of less than or equal to ½ of the Curie point of the piezoelectric material.

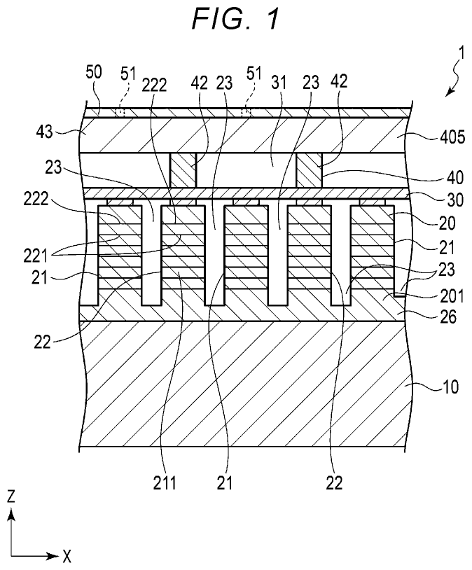

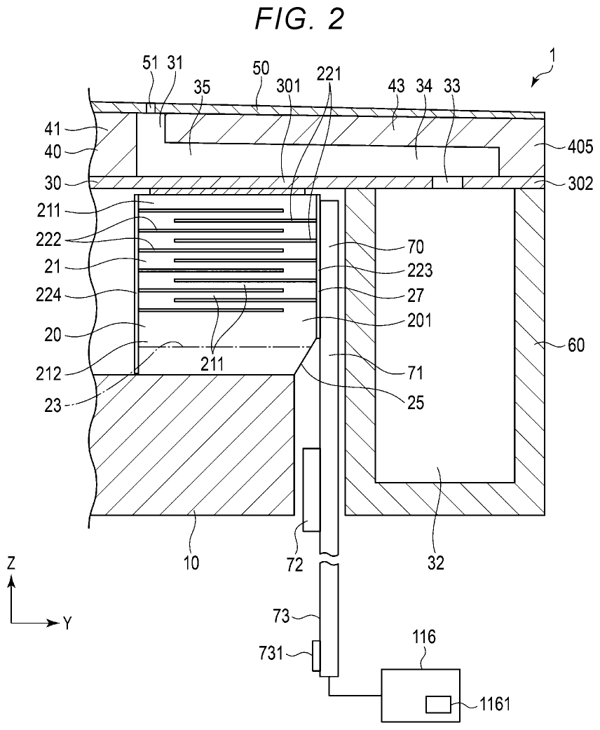

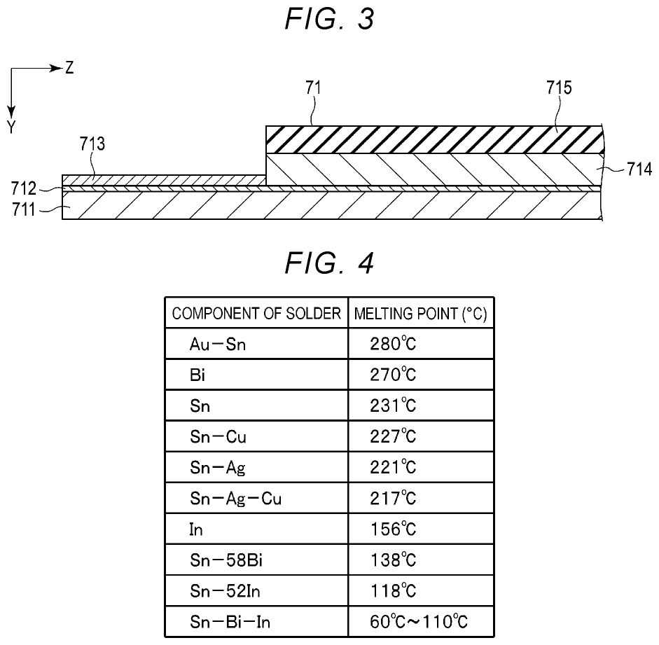

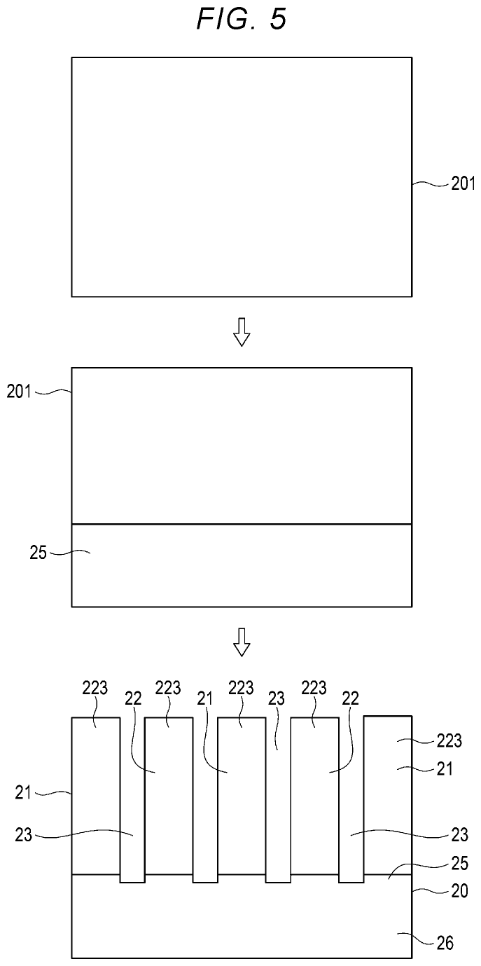

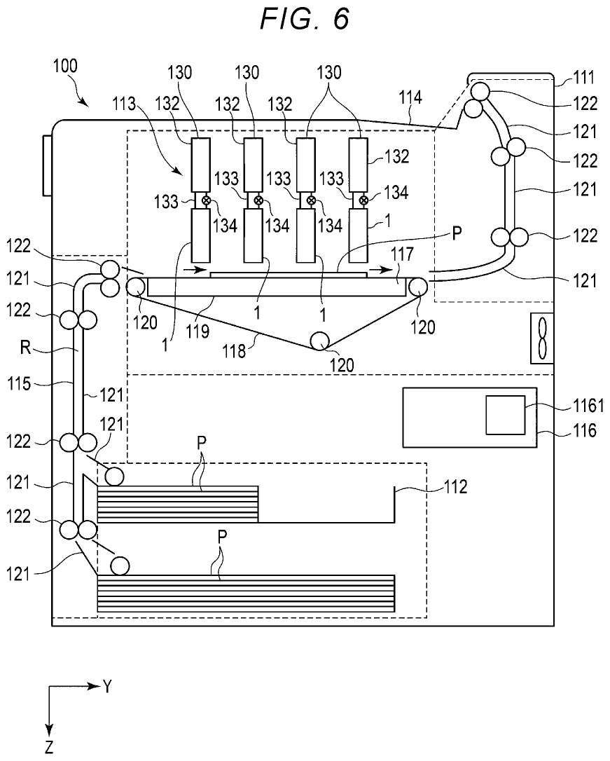

Hereinafter, an inkjet head 1 (which is a liquid ejecting head) and an inkjet recording apparatus 100 (which is a liquid ejecting apparatus) according to certain example embodiments will be described with reference to FIGS. 1 to 6. FIGS. 1 and 2 are cross-sectional views illustrating schematic configurations of the inkjet head 1. FIG. 3 is a cross-sectional view illustrating a configuration of a part of an FPC. FIG. 4 is a table of correspondence between types of solder and their melting points. FIG. 5 is a diagram illustrating aspects of a method for manufacturing the inkjet head 1. FIG. 6 is a diagram illustrating a schematic configuration of the inkjet recording apparatus 100. The aspects and/or elements depicted in the drawings are not necessarily to scale and relative dimensions and the like may be varied from actuality and from drawing to drawing for purposes of explanation.

As illustrated in FIGS. 1 and 2, the inkjet head 1 includes a base 10 (substrate), actuator units 20, a flow passage member 40, a nozzle plate 50 including a plurality of nozzles 51, a frame unit 60 serving as a structure unit, and a driving circuit 70. For example, the inkjet head 1 includes two actuator units 20, two nozzle rows in which the nozzles 51 are arranged along a row direction (the X direction), two pressure chamber rows in which pressure chambers 31 are arranged along the row direction, and two element rows in which piezoelectric elements 21 and 22 are arranged along the row direction. In the present embodiment, a stacking direction of piezoelectric layers 211, a vibration direction of the piezoelectric elements 21 and 22, and a vibration direction of a vibration plate 30 are oriented in the Z direction.

The actuator units 20 are joined to one side of the base 10. The actuator units 20 are provided, for example, on the base 10. For example, two actuator units 20 are disposed side by side in the Y direction. In FIGS. 1 and 2, only one actuator unit 20 is specifically depicted, but each actuator unit 20 has a similar structure.

The actuator unit 20 is formed from a piezoelectric material and includes a plurality of driving piezoelectric elements 21 and a plurality of non-driving piezoelectric elements 22 alternately arranged in the row direction, and a connection portion 26 connecting the plurality of piezoelectric elements 21 and 22 on the base 10 side.

In the actuator unit 20, the plurality of driving piezoelectric elements 21 and the plurality of non-driving piezoelectric elements 22 are arranged at a constant interval.

In this example, the driving piezoelectric elements 21 and the non-driving piezoelectric elements 22 are each configured in a rectangular parallelepiped columnar shape and have the same external shape. The actuator unit 20 is divided into a plurality of portions by a plurality of grooves 23 with the same width. The plurality of driving piezoelectric elements 21 and the plurality of non-driving piezoelectric elements 22 are thus all arranged at the same pitch by the grooves 23 therebetween.

For example, by setting the depth of the groove 23 to be less than the entire height of a stacked piezoelectric member 201 in the Z direction, the connection portion 26 can be formed integrally, and it is possible to form a shape in which one side is divided into a plurality of portions but the other side remains connected.

For example, the plurality of driving piezoelectric elements 21 and the plurality of non-driving piezoelectric elements 22 are each formed in a rectangular shape in which a transverse direction is oriented in the row direction of the element row and a longitudinal direction is oriented in an extension direction orthogonal to the row direction and the Z direction in a plan view when viewed in the Z direction.

The driving piezoelectric elements 21 are arranged at positions facing the plurality of pressure chambers 31 formed in the flow passage member 40 in the Z direction. For example, central positions of the driving piezoelectric elements 21 in the row direction and the extension direction and central positions of the pressure chambers 31 in the row direction and the extension direction are arranged side by side in the Z direction.

The non-driving piezoelectric elements 22 are arranged at positions facing a plurality of partition walls 42 formed in the flow passage member 40 in the Z direction. For example, the central positions of the driving piezoelectric elements 21 in the row direction and the extension direction and central positions of the partition walls 42 in the row direction and the extension direction are arranged side by side in the Z direction.

For example, the actuator unit 20, may be formed by forming the grooves 23 by dicing of a stacked piezoelectric material (e.g., stacked piezoelectric member 201, see also FIG. 5) may mounted/joined to stacked piezoelectric material before the dicing process. Electrodes or the like are provided for the plurality of columnar elements thus formed, and the plurality of driving piezoelectric elements 21 and the plurality of non-driving piezoelectric elements 22 alternately disposed are formed. The plurality of driving piezoelectric elements 21 and the plurality of non-driving piezoelectric elements 22 are disposed alternately in parallel with the grooves 23 interposed therebetween in the row direction.

For example, the stacked piezoelectric member 201 used for forming the actuator unit 20 is formed by stacking and baking (heating) sheet-shaped piezoelectric materials.

A piezoelectric material forming the driving piezoelectric element 21 and the non-driving piezoelectric element 22 is, for example, the stacked piezoelectric member 201 depicted in FIG. 5. The driving piezoelectric element 21 and the non-driving driving piezoelectric element 22 each include the stacked piezoelectric layers 211 and internal electrodes 221 and 222 formed in a main surface of each piezoelectric layer 211. For example, the driving piezoelectric element 21 and the non-driving piezoelectric element 22 have the same stacked structure. The driving piezoelectric element 21 and the non-driving piezoelectric element 22 include external electrodes 223 and 224 formed on surfaces thereof.

The piezoelectric layer 211 is formed, for example, as a thin sheet of a piezoelectric ceramic material such as a lead zirconate titanate (PZT)-based or lead-free sodium potassium niobate (KNN)-based material. The piezoelectric layers 211 are stacked and adhered (laminated) to each other. For example, the thickness direction and the stacking direction of the piezoelectric layers 211 in the present embodiment are disposed along the vibration direction (the Z direction).

The internal electrodes 221 and 222 are conductive films formed of a bakeable conductive material such as silver palladium in a predetermined shape. The internal electrodes 221 and 222 are formed in a predetermined region on the main surface of a piezoelectric layer 211. The internal electrodes 221 and 222 have different polarities from each other. For example, an internal electrode 221 is formed in a region at one end of the piezoelectric layer 211 extending in the Y direction but does not reach the other (opposite) end of the piezoelectric layer 211. An internal electrode 222 is formed at a region at the opposite end of the piezoelectric layer 211 extending in the Y direction but does not reach the opposite end of the piezoelectric layer (the end where the internal electrode 221 begins). The internal electrodes 221 and 222 are connected to the external electrodes 223 and 224 formed on the lateral surfaces of the piezoelectric elements 21 and 22, respectively.

The stacked piezoelectric member 201 configuring the driving piezoelectric element 21 and the non-driving piezoelectric element 22 further includes a dummy layer 212 on at least one on the base 10 side and a nozzle plate 50 side of the stack. The dummy layer 212 is formed of, for example, the same material as that of the piezoelectric layer 211 but is not deformed in operation since an electrode is formed on only one side and thus an electric field is not applied thereto (or thereacross). For example, the dummy layer 212 does not function as a piezoelectric body, but serves as a base for fixing the actuator unit 20 to the base 10, or serves as a polishing margin that might be utilized when the actuator unit 20 is polished for accuracy during or after assembly.

The external electrodes 223 and 224 are formed on the surfaces of the driving piezoelectric elements 21 and the non-driving piezoelectric elements 22, and configured to gather (lead out) ends of the internal electrodes 221 and 222. For example, the external electrodes 223 and 224 are formed on opposite end surfaces in the extension direction of the piezoelectric layer 211, respectively. The external electrodes 223 and 224 can be formed as a film of nickel (Ni), chromium (Cr), gold (Au), or the like using a known method such as a plating or sputtering method. The external electrodes 223 and 224 have different polarities. The external electrodes 223 and 224 are disposed on different lateral surfaces of the driving piezoelectric elements 21 and the non-driving piezoelectric elements 22.

In the present embodiment, the external electrode 223 serves as an individual electrode and the external electrode 224 serves as a common electrode. The external electrodes 223 (serving as the individual electrodes for the plurality of driving piezoelectric elements 21 and the plurality of non-driving piezoelectric elements 22) are formed with a junction portion 27 which is on one lateral surface of the stacked piezoelectric member 201, and the electrode layers are divided by the grooves 23 so that the external electrodes 223 can be independently addressed/operated. For the external electrodes 224 (serving as the common electrode), the electrode layers are connected to each other on the lateral surface of the stacked piezoelectric member 201 so that the external electrodes 224 are each connected to one another (for example, external electrodes 24 are ground terminals or the like).

Each external electrode 223 is connected to the driving circuit 70 via the FPC 71 (serving as a flexible substrate which is an example of a wiring substrate) at the junction 27 on the lateral surface of piezoelectric member 201). For example, each individual external electrode 223 is connected to a control unit 116 (serving as a driving unit) via a driving IC 72 of the driving circuit 70 by the FPC 71 and is configured so that driving can be independently controlled by a control circuit 1161. In other examples, the disposition of the common and individual electrodes may be reversed. The external electrodes 224 may be routed at the junction 27 on the external electrode 223 side and may be connected to the driving circuit 70 via the FPC 71. The dummy layer 212 is formed of the same material as that of the piezoelectric layer 211. The dummy layer 212 is not deformed since an electrode is formed on only one side and an electric field is not applied. That is, the dummy layer 212 does not function as a piezoelectric actuator, but serves as the base for fixing or as polishing margin.

A removal portion 25 that has an inclined surface obliquely inclined to the stacking direction is formed in an end on the base 10 side of a lateral surface on the individual electrode side of the stacked piezoelectric member 201 configuring the piezoelectric elements 21 and 22. The removal portion 25 is a chamfered portion formed by cutting the corner into a tapered shape so that a region of the piezoelectric element 21 at the end of the base 10 side is recessed in a direction away from the FPC 71.

The removal portion 25 extends in the stacking direction and the arrangement direction of the pressure chambers 31. For example, the removal portion 25 is provided in the dummy layer 212. That is, in the piezoelectric element 21, a portion which does not function as the piezoelectric body and is not deformed can be partially cut and formed in an inclined surface shape to provide the removal portion 25. In some examples, the removal portion 25 may be located in the piezoelectric layer 211. In this case, the removal portion 25 is formed at positions avoiding the internal electrodes 221 and 222 and the external electrodes 223 and 224.

The vibration direction of each of the piezoelectric elements 21 and 22 is oriented in the stacking direction and is displaced in a d33 direction by applying an electric field.

For example, each of the piezoelectric elements 21 and 22 comprises 3 to 50 layers, a thickness of each such stacked layer is set to 10 μm to 40 μm, and the layer thickness multiplied by the number of stacked layers is less than 1,000 μm.

The driving piezoelectric elements 21 vibrate when a voltage is applied to the internal electrodes 221 and 222 via the external electrodes 223 and 224. In the present embodiment, the driving piezoelectric elements 21 vertically vibrate in the stacking direction of the piezoelectric layers 211. The vertical vibration mentioned herein is, for example, “vibration in a thickness direction defined by a piezoelectric constant d33”. The driving piezoelectric elements 21 displace the vibration plate 30 to deform the pressure chambers 31.

The flow passage member 40 includes the vibration plate 30 disposed to face the actuator unit 20 in a deformation direction and a flow passage substrate 405 stacked on the vibration plate 30.

The vibration plate 30 is provided between the flow passage substrate 405 and the actuator units 20 in the vibration direction. The vibration plate 30 forms the flow passage member 40 together with the flow passage substrate 405.

The vibration plate 30 is joined to one side of the piezoelectric layers 211 of the plurality of piezoelectric elements 21 and 22 in the vibration direction, that is, the surface of the nozzle plate 50 side. The vibration plate 30 is configured to be deformable (flexible), for example. The vibration plate 30 is joined to the driving piezoelectric elements 21 and the non-driving piezoelectric elements 22 of the actuator units 20 and the frame unit 60. For example, the vibration plate 30 includes a vibration region 301 facing the piezoelectric elements 21 and 22 and a support region 302 facing the frame unit 60.

The vibration region 301 has, for example, a plate shape disposed so that the thickness direction is along the vibration direction of the piezoelectric layers 211. The vibration plate 30 extends in a surface direction oriented in the arrangement direction of the plurality of driving piezoelectric elements 21 and the plurality of non-driving piezoelectric elements 22. The vibration plate 30 is, for example, a metal plate. The vibration plate 30 has a plurality of vibration portions which face a pressure chamber 31 and can be displaced individually. The vibration plate 30 can be formed by integrally connecting the plurality of vibration portions.

For example, the vibration plate 30 is formed of nickel or a stainless steel (SUS) plate and a thickness dimension in the vibration direction is about 5 μm to 15 μm. In the vibration region 301, creases or steps may be formed in portions adjacent to the vibration portions or between the vibration portions adjacent to each other so that the plurality of vibration portions can be more easily displaced. The vibration region 301 is deformed when portions disposed to face the driving piezoelectric elements 21 are displaced through expansion and compression of the driving piezoelectric elements 21. For example, the vibration plate 30 is formed by an electroforming method or the like since a very thin and complicated shape may be necessary. The vibration plate 30 is joined to the upper end surfaces of the actuator units 20 by an adhesive or the like.

The support region 302 is a plate-shaped member disposed between the frame unit 60 and the flow passage substrate 405. The support region 302 includes a communication portion 33 that has a through-hole communicating with a common chamber 32.

For example, the communication portion 33 may include a filter member that has many pores through which a liquid can pass as the through-hole.

The flow passage substrate 405 is disposed between the nozzle plate 50 and the vibration plate 30. The flow passage substrate 405 is joined to one side of the vibration plate 30.

The flow passage substrate 405 includes a peripheral wall 41 joined to the outer edge of the vibration plate 30, the partition walls 42 partitioning ink passages 35, and a guide wall 43 that forms a guide flow passage 34. In the flow passage substrate 405, the ink passage 35 including the pressure chambers 31 is partitioned by the partition walls 42.

Inside the flow passage substrate 405, the plurality of pressure chambers 31 are partitioned by the partition walls 42. That is, both sides of the pressure chambers 31 are formed by partition walls 42. The pressure chambers 31 each communicate with one of the nozzles 51 formed in the nozzle plate 50. In the pressure chambers 31, the side opposite to the nozzle plate 50 is closed by the vibration plate 30.

The plurality of pressure chambers 31 are spaces formed on one side of the vibration region 301 of the vibration plate 30 and communicate with the common chamber 32 via the guide flow passage 34 and the communication portion 33. The plurality of pressure chambers 31 communicate with the nozzles 51 formed in the nozzle plate 50. In the pressure chambers 31, the side opposite to the nozzle plate 50 is closed by the vibration plate 30.

The plurality of pressure chambers 31 hold a liquid supplied from the common chamber 32 (via the guide flow passage 34) and are deformed by vibration of the vibration plate 30 to eject liquid from the nozzles 51.

The partition walls 42 are arranged in parallel and partition the plurality of guide flow passages 34 and also configure the lateral sides of both the guide flow passages 34 and the pressure chambers 31. The partition walls 42 are disposed to face the non-driving piezoelectric elements 22 via the vibration plate 30 and are supported by the non-driving piezoelectric elements 22. The plurality of partition walls 42 are provided at the same pitch as a pitch at which the plurality of pressure chambers 31 are arranged.

The nozzle plate 50 is formed in a rectangular plate shape with a thickness of about 10 μm to 100 μm and formed of, for example, a metal such as SUS—Ni or a resin such as a polyimide. The nozzle plate 50 is disposed on one side of the flow passage substrate 405 to cover an opening on one side of the pressure chambers 31.

The plurality of nozzles 51 are arranged to form nozzle rows. For example, the nozzles 51 are provided in two rows and the nozzles 51 are provided at positions corresponding to the plurality of pressure chambers 31 arranged in two rows. In the present embodiment, the nozzles 51 are provided at positions near the ends of the pressure chambers 31 in the extension direction.

The frame unit 60 is a structure joined to the vibration plate 30 together with the piezoelectric elements 21 and 22. The frame unit 60 is provided on the side of the piezoelectric elements 21 and 22 and the vibration plate 30 opposite to the flow passage substrate 405 and is, for example, disposed to be adjacent to the actuator unit 20 in the present embodiment. The frame unit 60 configures the outline (outer perimeter) of the inkjet head 1. The frame unit 60 may form a portion of a liquid flow passage inside. In the present embodiment, the frame unit 60 is joined to the vibration plate 30 and the common chamber 32 is formed between the frame unit 60 and the vibration plate 30.

The common chamber 32 is formed inside the frame unit 60 and communicates with the pressure chambers 31 via the guide flow passages 34 and the communication portions 33 provided in the vibration plate 30.

The driving circuit 70 has a flexible printed circuit (FPC) 71 of which one end is connected to the external electrodes 223 and 224. The driving IC 72 is mounted on the FPC 71, and a printed wiring substrate 73 mounted on the other end of the FPC 71 from the external electrodes 223 and 224.

The driving circuit 70 drives the driving piezoelectric elements 21 by applying a driving voltage to the external electrodes 223 and 224 by the driving IC 72 and ejects liquid droplets from the nozzles 51 by increasing and decreasing volumes of the pressure chambers 31.

The FPC 71 is connected to the plurality of external electrodes 223 and 224. As the FPC 71, a chip-on film (COF) on which the driving IC 72 is mounted as an electronic component can be used.

The FPC 71 is connected to the junction 27 on the lateral surface of the stacked piezoelectric member 201. As illustrated in FIG. 3, the FPC 71 includes a base layer 711, an electrode layer 712, a solder layer 713, an adhesion layer 714, and an insulation cover layer 715.

The base layer 711 can be a polyimide sheet or the like. The electrode layer 712 is formed of a conductive material such as a metal and is formed in a predetermined pattern on the surface of the base layer 711. The electrode layer 712 is, for example, a copper foil or the like. On a surface of the electrode layer 712, the solder layer 713 is formed over a junction region that is to be joined to the piezoelectric elements 21. The solder layer 713 is formed by solder plating to a thickness of about 3 μm to 10 μm. In outside the junction region on the surface of the electrode layer 712, the insulation cover layer 715 can be formed with the adhesion layer 714 interposed therebetween.

The FPC 71 is electrically and mechanically connected to the external electrodes 223 by causing the junction region (where the solder layer 713 is formed) to face the junction 27, appropriately aligning the junction region with the junction 27, heating the junction region, and melting the solder of the solder layer 713. In some examples, the FPC 71 may be connected to some of the external electrodes 224 which may be routed to the junction 27. The heating may be performed by using a general heating tool or emitting an infrared laser or the like passing through the base layer 711 of the FPC 71. The joining may be performed by solder by pressurization of, for example, about 100 g although the pressurization may be different depending on conditions such as warpage tolerance of components.

For the solder layer 713, a type of lead-free solder with a melting point equal to or less than ½ of the Curie point of the piezoelectric material used in the actuator unit 20 while still being equal to or greater the highest temperature at the junction 27 during operations (highest attainment temperature) can be selected from among various types of solder, such as those shown in FIG. 4. Here, the highest attainment temperature at the junction 27 is the highest temperature at the junction 27 that may be assumed (or estimated) to occur during the driving of the inkjet head 1. For example, the highest attainment temperature is a predetermined value calculated based on an expected heat generation temperature of the driving IC 72. A temperature of a mounted portion becomes higher due to the heat generated by the piezoelectric body and thermal insulation of heat of the driving IC 72 via the FPC 71. For example, the temperature of the mounted portion in printing at a duty ratio of 100% may be assumed to result in the highest attainment temperature. Alternatively, a highest expected operating temperature of an element such as the driving IC 72 or the piezoelectric member 201 may be set as the highest attainment temperature for the junction 27. It may be preferable in most instances to use solder with a melting point of at least 90° C. The duty ratio in this context is the ratio of the period of a driving signal (pulse signal) to the maximum pulse width of the driving signal and is expressed in the following expression:

duty ratio=pulse width of driving signal/period of driving signal (pulse signal).

For example, as the solder of the solder layer 713, tin-bismuth-indium (Sn—Bi—In) alloy with a melting point in the range of 60° C. to 110° C., Sn-52In alloy with a melting point of 118° C., Sn-58Bi alloy with of melting point of 138° C., indium (In) with a melting point of 156° C., or the like may be used. For example, a Curie point of a piezoelectric material is about 300° C., and Sn—In-based or Sn—Bi-based solder can thus be appropriate for an injection head incorporating the stacked piezoelectric member 201 in which the highest attainment temperature for the junction 27 is considered to be 82° C.

In the FPC 71, the thickness outside the junction region can be greater than the thickness of the junction region due to the difference between the thickness of the solder layer 713 and a sum of the thicknesses of the insulation cover layer 715 and the adhesion layer 714, and thus a step is formed on the surface of the FPC 71. The solder layer 713 is disposed to face the junction 27, and the insulation cover layer 715 is disposed to face the removal portion 25.

The driving IC 72 is connected to the external electrodes 223 and 224 via the FPC 71. The driving IC 72 is an electronic component used for ejection control.

The driving IC 72 generates a control signal and a driving signal for operating each driving piezoelectric element 21. The driving IC 72 generates a control signal for control such as an ink ejection timing or selection of the driving piezoelectric elements 21 ejecting ink in accordance with an image signal input from the control unit 116 of the inkjet recording apparatus 100 on which the inkjet head 1 is mounted. The driving IC 72 generates a voltage to be applied to the driving piezoelectric elements 21, that is, a driving signal, in accordance with the control signal from the control unit 116. If the driving IC 72 applies the driving signal to the driving piezoelectric elements 21, the driving piezoelectric elements 21 are driven to displace the vibration plate 30 and change the volumes of the pressure chambers 31. Accordingly, the ink filled in the pressure chambers 31 causes pressure vibration. Because of the pressure vibration, the ink is ejected from the nozzles 51 communicating with the pressure chambers 31. The inkjet head 1 may be configured to realize grayscale expression by changing the number or volume of ink droplets to be landed to one pixel. The inkjet head 1 may be configured so that the number of ink droplets to be landed to one pixel can be changed by changing the number of times the ink is ejected. In this way, the driving IC 72 is an example of an application unit that applies the driving signal to the driving piezoelectric elements 21.

For example, the driving IC 72 includes a data buffer, a decoder, and a driver. The data buffer stores time-series printing data for each driving piezoelectric element 21. The decoder controls the driver based on the printing data stored in the data buffer for each driving piezoelectric element 21. The driver outputs the driving signal for operating each driving piezoelectric element 21 under the control of the decoder. The driving signal is, for example, a voltage to be applied to each driving piezoelectric element 21.

The printed wiring substrate 73 can also be referred to as a printing wiring assembly (PWA) on which various electronic components or connectors may be mounted and includes a head control circuit 731. The printed wiring substrate 73 is connected to the control unit 116 of the inkjet recording apparatus 100.

In the inkjet head 1, ink flow passages including the plurality of pressure chambers 31 communicating with the nozzles 51, a plurality of guide flow passages 34 respectively communicating the plurality of pressure chambers 31, and the common chamber 32 communicating with the plurality of guide flow passages 34 are formed by the nozzle plate 50, the frame unit 60, the flow passage substrate 405, and the vibration plate 30. For example, the common chamber 32 connects to a cartridge so that ink can be supplied to each pressure chamber 31 via the common chamber 32. All the driving piezoelectric elements 21 are connected so that a voltage can be applied by wirings. In the inkjet head 1, the driving piezoelectric elements 21 of the driving target vibrate in, for example, the stacking direction, that is, the thickness direction of each piezoelectric layer 211, for example, if the control unit 116 of the inkjet recording apparatus 100 applies the driving voltage to the electrodes 221 and 222 by the driving IC 72. That is, the driving piezoelectric elements 21 vertically vibrate.

Specifically, the control unit 116 applies the driving voltage to the internal electrodes 221 and 222 of the driving piezoelectric elements 21 to selectively drive particular driving piezoelectric elements 21 as necessary. Then, by deforming the vibration plate 30 in combination of deformation in a tensile direction and deformation in a compression direction by the driving piezoelectric elements 21 of the driving target and changing the volumes of the pressure chambers 31, a liquid is guided from the common chamber 32 to be ejected from the nozzles 51.

An example of a method for manufacturing the inkjet head 1 according to the present embodiment will be described. First, the internal electrodes 221 and 222 are formed of a piezoelectric material formed in a sheet shape by a printing process (e.g., a lithographic method). The plurality of piezoelectric layers 211 including the internal electrodes 221 and 222 are stacked to form the stacked piezoelectric member 201 by a baking process and a polarization process.

Then, the stacked piezoelectric member 201 in which the internal electrodes 221 and 222 are formed in advance is disposed on the base 10. For example, if two actuator units 20 are to be formed, the stacked piezoelectric member 201 may be divided into two by a grooving process after the integrally configured stacked piezoelectric member 201 is joined to the base 10, or alternatively two stacked piezoelectric members 201 configuring the two actuator units 20 may be prepared separately.

Subsequently, the external electrodes 223 and 224 are formed on end surfaces of the stacked piezoelectric member 201 by a printing process. Then, the removal portion 25 is formed on the end at which the external electrodes 223 are disposed by a dicing process. The electrode layer of the portion on the base 10 side of the external electrode 223 is removed by forming the removal portion 25. Further, by forming the plurality of grooves 23 with a depth reaching portions in which electrodes are removed by the removal portion 25, one side of the stacked piezoelectric member 201 in the Z direction is divided into a plurality of pieces. In this way, the stacked piezoelectric member 201 of which one end is divided into a plurality of portions and the other end is still connected is formed. At this time, by forming the plurality of grooves 23 at a predetermined pitch and dividing the stacked piezoelectric member 201 into the plurality of portions, a plurality of columnar elements serving as the plurality of piezoelectric elements 21 and 22 arranged at the same pitch can be formed. In this way, the plurality of driving piezoelectric elements 21 and the plurality of non-driving piezoelectric elements 22 arranged at the same pitch are formed.

Here, by forming the grooves 23 at the depth reaching the removal portion 25 in which the electrode layers are removed, the electrode layers on the side on which the removal portion 25 is formed serve as independently individual electrodes separated from each other. On the other hand, the electrode layers on the lateral surface in which the removal portion 25 is not formed configure the common electrodes in which the electrode layers continue in a region closer to the base 10 than the bottoms of the grooves. Further, adhesion to the base 10 is performed with an adhesive or the like by performing a polarization process of the piezoelectric elements 21.

In the junction 27, the FPC 71 is connected to the external electrodes 223 and 224, for example, by solder mounting or the like. Further, the printed wiring substrate 73 including the head control circuit 731 is connected to the FPC 71.

The vibration plate 30, the flow passage substrate 405, and the nozzle plate 50 are stacked and positioned on the actuator units 20 with joining materials interposed therebetween, the frame units 60 are disposed on the outer circumference of the actuator units 20, the plurality of members are joined to complete the inkjet head 1.

Hereinafter, an example of the inkjet recording apparatus 100 including the inkjet head 1 will be described with reference to FIG. 6. The inkjet recording apparatus 100 includes a casing 111, a medium supply unit 112, an image forming unit 113, a medium discharging unit 114, a conveyance device 115, and a control unit 116.

The inkjet recording apparatus 100 is a liquid ejecting apparatus that performs an image forming process on a sheet P by ejecting a liquid such as ink while conveying the sheet P serving as a printing medium from the medium supply unit 112 through the image forming unit 113 along a predetermined conveyance path R reaching the medium discharging unit 114.

The casing 111 forms the outside of the inkjet recording apparatus 100. A discharging port through which the sheet P is discharged outside is included at a predetermined portion of the casing 111.

The medium supply unit 112 includes a plurality of feeding cassettes and is configured so that the plurality of sheets P with various sizes are stacked and retained.

The medium discharging unit 114 includes a discharging tray configured to retain the sheet P discharged from the discharging port.

The image forming unit 113 includes a support unit 117 that supports the sheet P and includes a plurality of head units 130 disposed to face the upper side of the support unit 117.

The support unit 117 includes a conveyance belt 118 that is provided in a loop shape in a predetermined region where image forming is performed, a support plate 119 that supports the conveyance belt 118 from a rear side, and a plurality of belt rollers 120 provided on the rear side of the conveyance belt 118.

The support unit 117 conveys the sheet P downstream by supporting the sheet P on a retainment surface which is the upper surface of the conveyance belt 118 and feeding the conveyance belt 118 at a predetermined timing with rotation of the belt rollers 120.

The head unit 130 includes a plurality of inkjet heads 1 (e.g., four-color heads), ink tanks 132 for each of the inkjet heads 1, connection flow passages 133 connecting the inkjet heads 1 to the respective ink tanks 132, and supply pumps 134.

In the present embodiment, the inkjet heads 1 of four colors, cyan, magenta, yellow, and black and an ink tank 132 for each are included. The ink tanks 132 are connected to the respective inkjet heads 1 by a connection flow passage 133.

A negative pressure control device such as a pump or the like is connected to the ink tank 132. By providing a negative pressure (relative to water head pressures at the inkjet heads 1), the ink supplied to each nozzle 51 of the inkjet head 1 can be formed in a meniscus of a predetermined shape.

The supply pump 134 is, for example, a liquid feeding pump such as a piezoelectric pump. The supply pump 134 is provided in a supply flow passage. The supply pump 134 is connected to the control circuit 1161 of the control unit 116 by a wiring and is configured so that the supply pump 134 can be controlled by the control unit 116. The supply pump 134 supplies a liquid to the inkjet head 1.

The conveyance device 115 conveys the sheet P from the medium supply unit 112 through the image forming unit 113 along the conveyance path R. The conveyance device 115 includes a plurality of guide plate pairs 121 disposed along the conveyance path R and a plurality of conveyance rollers 122.

Each of the guide plate pairs 121 includes a pair of plate members disposed to face each other with the conveyed sheet P passing therebetween and serves to guide the sheet P along the conveyance path R.

The conveyance rollers 122 are driven to be rotated under the control of the control unit 116 so that the sheet P is conveyed downstream along the conveyance path R. In the conveyance path R, a sensor detecting a sheet conveyance status is disposed at each relevant position.

The control unit 116 includes a control unit 1161 such as a CPU (central processing unit), a read-only memory (ROM) that stores various programs and the like, a random access memory (RAM) that temporarily stores various types of variable data, image data, and the like, and an interface unit that inputs data from the outside and outputs data to the outside.

In the inkjet recording apparatus 100, if a printing instruction given by a user operating an operation input unit in an interface is detected, the control unit 116 drives the inkjet heads 1 by driving the conveyance device 115 to convey the sheet P and outputs a printing signal to the head units 130 at a predetermined timing. The inkjet heads 1 transmit a driving signal to the driving IC 72 as an image signal in accordance with image data for an ejecting operation, applying the driving voltages to the internal electrodes 221 and 222, selectively to drive the piezoelectric elements 21 to vibrate to eject the ink from the necessary nozzles 51 by changing the volumes of the pressure chambers 31, and thus form an image on the sheet P on the conveyance belt 118. As a liquid ejecting operation, the control unit 116 supplies the ink from the ink tanks 132 to the common chambers 32 of the inkjet heads 1 by driving the supply pumps 134.

Here, a driving operation of driving the inkjet head 1 will be described. The inkjet head 1 according to the present embodiment includes the driving piezoelectric element 21 disposed to face the pressure chamber 31, and the driving piezoelectric element 21 is connected by a wiring so that a voltage can be applied. The control unit 116 transmits a driving signal to the driving IC 72 by an image signal in accordance with image data, applies a driving voltage to the internal electrodes 221 and 222 of the driving piezoelectric element 21 of the driving target, and selectively deforms the driving piezoelectric element 21 of the driving target. Then, a liquid is ejected by changing the volume of the pressure chamber 31 in combination of deformation in the tensile direction and deformation in the compression direction of the vibration plate 30.

For example, the control unit 116 alternately performs a expanding and compression operation. In the inkjet head 1, in the expanding operation of increasing an internal volume of the target pressure chamber 31, the driving piezoelectric element 21 of the driving target is contracted and the driving piezoelectric element 21 which is not the driving target is not deformed. In the inkjet head 1, in the compression operation of decreasing the internal volume of the target pressure chamber 31, the driving piezoelectric element 21 of the target is stretched. The non-driving piezoelectric element 22 is not deformed.

In the inkjet head 1 and the inkjet recording apparatus 100 according to the above-described embodiment, the FPC 71 can be directly joined to the electrodes of the piezoelectric member by solder. That is, by setting a melting point of the solder within a range equal to or less than ½ of the Curie point of the piezoelectric member material, it is possible to perform mounting with high reliability without deterioration. For example, the PZT generally has a deterioration point which is about ½ of the Curie point. However, by setting the melting point of the solder of the solder layer 713 of the FPC 71 to be equal to or less than ½ of the Curie point of the piezoelectric material, it is possible to prevent the piezoelectric material from deteriorating. Since an electronic component such as the driving IC 72 mounted on the FPC 71, the piezoelectric body, and the periphery of the piezoelectric body generate heat during operation and the piezoelectric body itself generates heat when driven, the temperature at junction 27 may increase to about 80° C. to 90° C., for example. Therefore, if the melting point of the solder used at the junction 27 is too low, reliability in operation deteriorates. In the present embodiment, by setting the melting point of the solder to be equal to or greater than the highest attainment temperature expected at the junction 27, it is possible to prevent the solder from being melted during the operation and avoid a mounting failure (connection failure).

With soldering, the FPC can be directly mounted on a piezoelectric structure portion by solder and the joining is performed without pressurization. Therefore, the thin and fragile piezoelectric elements divided by the grooves can be mounted without being damaged. In particular, the piezoelectric elements can be mounted without applying large pressures even in a configuration in which a joining strength of the piezoelectric material and the electrode material as in the stacked piezoelectric member 201 is weak.

The present disclosure is not limited to the foregoing example and aspects can be modified and still be within the scope of the embodiment without departing from the gist of the present disclosure.

A specific material or configuration of the piezoelectric elements 21 and 22 t may be appropriately changed.

In an embodiment, the plurality of piezoelectric layers 211 are stacked and the driving piezoelectric elements 21 are driven through the vertical vibration (d33) in the stacking direction, but the present disclosure is not limited thereto. For example, the present disclosure can also be applied to a form in which the driving piezoelectric elements 21 are configured as a single-layered piezoelectric member or a form in which the driving piezoelectric elements 21 are driven through lateral vibration displaced in a d31 direction.

The arrangement of the nozzles 51 or the pressure chambers 31 is not limited. For example, the nozzles 51 may be arranged in two or more rows. An air chamber serving as a dummy chamber may be formed between the plurality of pressure chambers 31. The inkjet head of an embodiment may be either a non-circulation type inkjet head or a circulation type inkjet head or either a side-shooter type inkjet head or an end-shooter inkjet head.

An example in which the piezoelectric elements 21 and 22 include the dummy layers 212 at both ends in the stacking direction is described but the present disclosure is not limited thereto. A dummy layer 212 may be included on only one side of the piezoelectric elements 21 and 22, or excluded entirely. In addition, a configuration or a positional relationship of various components including the flow passage member 40, the nozzle plate 50, and the frame unit 60 can be appropriately changed.

An example in which the driving IC 72 functions as the heat generating element setting the highest attainable temperature was described, but the present disclosure is not limited thereto. For example, the heat generating element of concern may be a mounted component other than the driving IC 72 or may be the actuator unit 20.

A liquid to be ejected is not limited to printing ink. For example, an apparatus or the like ejecting a liquid containing conductive particles for forming a wiring pattern of a printed wiring substrate may be used.

In an embodiment, the inkjet head 1 is used for a liquid ejecting apparatus such as an inkjet printer is described, but the present disclosure is not limited thereto. For example, the inkjet head 1 can also be advantageously used for a 3D printer, an industrial manufacturing machine, a medical device, or the like.

According to at least one of the above-described embodiments, it is possible to easily set a desired flow passage shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid ejecting head, comprising:
a piezoelectric member including a plurality of piezoelectric elements formed of a piezoelectric material;
a plurality of electrodes formed on the piezoelectric member; and
a wiring substrate joined to the plurality of electrodes by solder, wherein
a melting point of the solder is less than or equal to ½ of the Curie point of the piezoelectric material.

2. The liquid ejecting head according to claim 1, wherein the melting point of the solder is greater than a highest attainment temperature at a junction between the piezoelectric member and the wiring substrate during a liquid ejection operation.

3. The liquid ejecting head according to claim 2, wherein the highest attainment temperature is a peak temperature during the liquid ejection operation performed at a duty ratio of 100%.

4. The liquid ejecting head according to claim 3, wherein the solder is lead-free.

5. The liquid ejecting head according to claim 2, wherein the highest attainment temperature is in a range of 80° C. to 90° C. or less.

6. The liquid ejecting head according to claim 1, wherein the solder is lead-free.

7. The liquid ejecting head according to claim 6, wherein the piezoelectric material comprises lead zirconate titanate.

8. The liquid ejecting head according to claim 6, wherein the piezoelectric material comprises sodium potassium niobate.

9. The liquid ejecting head according to claim 1, wherein the piezoelectric material comprises lead zirconate titanate.

10. The liquid ejecting head according to claim 1, wherein the piezoelectric material comprises sodium potassium niobate.

11. The liquid ejecting head according to claim 1, wherein the piezoelectric elements comprise a plurality of piezoelectric layers stacked one on the other.

12. The liquid ejecting head according to claim 11, wherein the piezoelectric elements include internal electrode layers connected to the plurality of electrodes.

13. The liquid ejecting head according to claim 12, wherein the wiring substrate is a flexible printed circuit.

14. The liquid ejecting head according to claim 12, wherein the flexible printed circuit is directly soldered to piezoelectric elements.

15. The liquid ejecting head according to claim 12, wherein the wiring substrate is directly soldered to a lateral surface of the piezoelectric elements.

16. The liquid ejecting head according to claim 11, wherein the wiring substrate is a flexible printed circuit.

17. The liquid ejecting head according to claim 1, wherein the wiring substrate is a flexible printed circuit.

18. A liquid ejecting apparatus, comprising:
a liquid ejecting head configured to eject droplets of a liquid, the liquid ejecting head including:
a piezoelectric member including a plurality of piezoelectric elements formed of a piezoelectric material;
a plurality of electrodes formed on the piezoelectric member; and
a wiring substrate joined to the plurality of electrodes by solder, wherein
a melting point of the solder is less than or equal to ½ of the Curie point of the piezoelectric material.

19. The liquid ejecting apparatus according to claim 18, wherein the wiring substrate is directly soldered to a lateral surface of the piezoelectric elements.

20. The liquid ejecting apparatus according to claim 18, wherein the melting point of the solder is greater than 90° C.
